(19) United States
(12) Patent Application Publication
(10) Pub. No.: US 2026/0259238 A1
(43) Pub. Date: Sep. 3, 2026

(54) AUTOMATED CONTAINER ALIGNMENT SYSTEM FOR FLUIDIC SAMPLE ANALYSES

(71) Applicant: Elemental Scientific, Inc., Omaha, NE (US)

(72) Inventors: Matthew Anderson, Omaha, NE (US); Daniel R Wiederin, Omaha, NE (US); Tyler Herek, Omaha, NE (US)

(21) Appl. No.: 19/549,831

(22) Filed: Feb. 25, 2026

Related U.S. Application Data
(60) Provisional application No. 63/764,821, filed on Feb. 28, 2025.

(51) Int. Cl. G01N 35/04; G01N 35/00

(52) U.S. Cl. CPC G01N 35/04; G01N 35/00584; G01N 2035/0405; G01N 2035/0422; G01N 2035/0496

(57) ABSTRACT

Systems and methods for automated alignment and transfer of sample containers for access by an autosampler system are described. In an aspect, a system includes, but is not limited to, a container aligner including a rotatable container receptacle configured to receive a sample container containing a fluid sample for analysis; and a container placement system configured to retrieve a sample container from an initial position on a sample deck and place the sample container into the container receptacle, wherein the container aligner is configured to rotate the container receptacle to receive the sample container in an initial rotational orientation and to further rotate the container receptacle from the initial rotational orientation to align the sample container with a second container receptacle following transition of the sample container to the second container receptacle by the container placement system.

### CROSS-REFERENCE TO RELATED APPLICATIONS

The present application claims the benefit of 35 U.S.C. § 119(e) of U.S. Provisional Application Serial No. 63/764,821, filed February 28, 2025, and titled “AUTOMATED CONTAINER ALIGNMENT SYSTEM FOR FLUIDIC SAMPLE ANALYSES.” U.S. Provisional Application Serial No. 63/764,821 is herein incorporated by reference in its entirety.

### BACKGROUND

In many laboratory settings, it is often necessary to analyze a large number of chemical or biochemical samples at one time. In order to stream-line such processes, the manipulation of samples has been mechanized. Such mechanized sampling is commonly referred to as autosampling and is performed using an automated sampling device or autosampler.

### SUMMARY

Systems and methods for automated alignment and transfer of sample containers for access by an autosampler system are described. In an aspect, a system includes, but is not limited to, a container aligner including a rotatable first container receptacle configured to receive a sample container containing a fluid sample for analysis; a container placement system configured to retrieve a sample container having a cap positioned on a container base, the sample container having an initial position on a sample deck, the container placement system configured to transfer the sample container from the initial position to the first container receptacle; an uncapper system configured to remove the cap from the container base, the uncapper system including a second container receptacle; and a computer controller communicatively coupled with the container aligner and the container placement system, the computer controller configured to instruct the container aligner to rotate the first container receptacle to receive the sample container in an initial rotational orientation, and instruct the container aligner to further rotate the container receptacle from the initial rotational orientation to a second rotational orientation to align the sample container with the second container receptacle following transition of the sample container to the second container receptacle by the container placement system.

In an aspect, a system includes, but is not limited to, a container aligner including a rotatable container receptacle configured to receive a sample container containing a fluid sample for analysis; and a container placement system configured to retrieve a sample container from an initial position on a sample deck and place the sample container into the container receptacle, wherein the container aligner is configured to rotate the container receptacle to receive the sample container in an initial rotational orientation and to further rotate the container receptacle from the initial rotational orientation to align the sample container with a second container receptacle following transition of the sample container to the second container receptacle by the container placement system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a schematic view of a sample container and fluid handling system including an automated container aligner in accordance with an example embodiment of the present disclosure.

FIG. 2 is a perspective view of a sample container and fluid handling system including an automated container aligner and shown with a container placement system interacting with a non-cylindrical sample container in accordance with an example embodiment of the present disclosure.

FIG. 3 is a diagrammatic top view of a sample container and fluid handling system, shown with a container placement system rotated and translated according to a variety of positions and with an automated container aligner shown rotated according to a variety of positions in accordance with an example embodiment of the present disclosure.

FIG. 4A is a perspective view of a sample container and fluid handling system including an automated container aligner and shown with a container placement system interacting with a non-cylindrical sample container in accordance with an example embodiment of the present disclosure.

FIG. 4B is a perspective view of the sample container and fluid handling system of FIG. 4A, shown with the container placement system having lifted the non-cylindrical sample container and with the automated container aligner having rotated in anticipation of receipt of the non-cylindrical sample container.

FIG. 4C is a perspective view of the sample container and fluid handling system of FIG. 4A, shown with the container placement system having introduced the non-cylindrical sample container to the automated container aligner.

FIG. 4D is a perspective view of the sample container and fluid handling system of FIG. 4A, shown with the automated container aligner having rotated the non-cylindrical sample container to conform to an orientation of a container receptacle at a rotary uncapper following rotation and translation of the container placement system.

FIG. 4E is a perspective view of the sample container and fluid handling system of FIG. 4A, shown with the container placement system having transferred the non-cylindrical sample container the container receptacle at the rotary uncapper.

FIG. 4F is a perspective view of the sample container and fluid handling system of FIG. 4A, shown with the rotary uncapper having repositioned the non-cylindrical sample container beneath an uncapper head.

FIG. 5 is a perspective view of a container receptacle of the automated container aligner of FIG. 4A.

FIG. 6 is a schematic view of a control system for a sample container and fluid handling system including an automated container aligner in accordance with an example embodiment of the present disclosure.

### DETAILED DESCRIPTION

### Overview

An automated sampling device, or autosampler, can support a sample probe with a support rod (e.g., a vertically-oriented support post) which moves the sample probe along or across one or more directions of movement. For instance, the sample probe can be coupled to a vertically-moveable portion of the rod by a probe support arm or other device to move the probe in a vertical direction, such as to position the probe into and out of sample containers (e.g., tubes or other vessels), rinse containers, standard chemical containers, diluent containers, and the like, on a deck of the autosampler. In other situations, the rod can be rotated to facilitate movement of the probe about a horizontal plane, such as to position the probe above other sample containers and other containers positioned on the deck.

Sample containers positioned on the deck can be supported by sample racks or sample holders to position the sample containers in discrete positions for access by the sample probe. The sample containers can be covered by a cap, lid, septum, or other structure to prevent external contamination of the sample held within the sample container, to prevent portions of the sample from evaporating, spilling, or otherwise leaving the sample container, to provide separation of potentially hazardous materials contained in the sample containers from nearby individuals (e.g., laboratory staff), and the like. In order for the sample probe to interact with samples contained within sealed sample containers or for reagents, diluents, internal standard chemicals, or other materials to be added, the sealing device (e.g., cap, lid, septum, etc.) can be pierced by the sample probe or removed to provide access to the interior of the sample container. Traditional vial uncapping methods are labor-intensive and prone to human error. Manual uncapping often requires repetitive motions that can lead to physical strain or injury for operators and exposes samples to potential contamination from environmental factors or human contact. In scenarios where vials contain hazardous or dangerous substances, manual handling poses a risk to the safety of users. Further, manual uncapping and repositioning by laboratory staff can lead to incorrect placement of sample containers within sample racks, such as for systems that depend on a particular positioning or orientation of samples within specific locations within a sample rack.

While automated uncapper systems can be utilized to remove sealing devices from sample containers, traditional uncappers do not account for non-cylindrically-shaped sample containers, which can have a non-circular footprint that may require a specific alignment in order to be received by the uncapper system. Robotic systems and gantry-based systems can be utilized to manipulate non-cylindrically-shaped sample containers into a proper orientation (e.g., about multiple axes or regions of rotation), however such systems include complex mechanical components, such as motors and gearing, that move above an autosampler deck to manipulate the containers, thereby providing multiple failure points to a moving system and potentially exposing sample containers to contamination by wear and tear of the mechanical system components used to manipulate the sample containers.

Accordingly, the present disclosure is directed, at least in part, to systems and methods for automating transfer and alignment of sample containers (e.g., non-cylindrically-shaped sample containers) from a first location to a second location for access by an autosampler system. In an aspect, a container placement system includes a grip mechanism configured to interact with a covered sample container to move the covered sample container from a first location (e.g., a sample rack) to an intermediate location of an automated container aligner that rotates the sample container to conform to an orientation of a container receptacle at a rotary uncapper at a third location following rotation and translation of the grip mechanism from the automated container aligner to the container receptacle at the rotary uncapper. In an aspect, the grip mechanism is supported by a rod that provides translational motion via movement through a slot in an autosampler deck (e.g., via a motor) and rotation of the rod through pivoting of the rod. The grip mechanism can also be raised and lowered along the rod to facilitate placement of the grip mechanism adjacent to sample containers such that the grip mechanism can grip and release a portion of the sample container, such as a cap, the body of the sample container, or combinations thereof.

The amount of rotation of the sample container provided by the automated container aligner is related to the initial position of the sample container on the autosampler deck prior to being lifted by the container placement system. For example, the automated container aligner includes a container receptacle positioned at a first angle (e.g., relative to a vertical axis) offset from the original angle of the sample container on the autosampler deck based on an angle of rotation of the grip mechanism by the rod of the container placement system as the rod rotates the grip mechanism from the initial position of the sample container to the container receptacle at the automated container aligner. Following introduction of the sample container to the container receptacle, the automated container aligner then rotates the container receptacle to a second angle offset from an angle of a container receptacle at the rotary uncapper based on an angle of rotation of the grip mechanism by the rod of the container placement system as the rod rotates the grip mechanism from the position at the automated container aligner to the container receptacle of the rotary uncapper.

In an aspect, the grip mechanism does not directly rotate the sample container (e.g., via a separate motor working on the cap), but rather, all motion of the sample container is provided through translation and rotation of the rod supporting the grip mechanism and through rotation of the sample container at the automated container aligner. Such configuration can prevent substantial amounts of moving mechanical parts above the sample container, which minimizes the potential contamination hazard from wear and tear on the mechanical components above the sample container, while facilitating use of sample containers having a variety of shapes, profiles, and container footprints.

In an aspect, the automated sample container and fluid handling system limits the amount of time vials are open to reduce risk of contamination and eliminates user interaction with the contents of the vials, thus protecting the user from exposure to harmful substances. In implementations, the materials used in the construction of the automated sample container and fluid handling system are selected for corrosion resistance, which can ensure component longevity and reliability, even when handling vials containing corrosive substances, thereby maintaining operational efficiency and minimizing maintenance requirements.

### Example Implementations

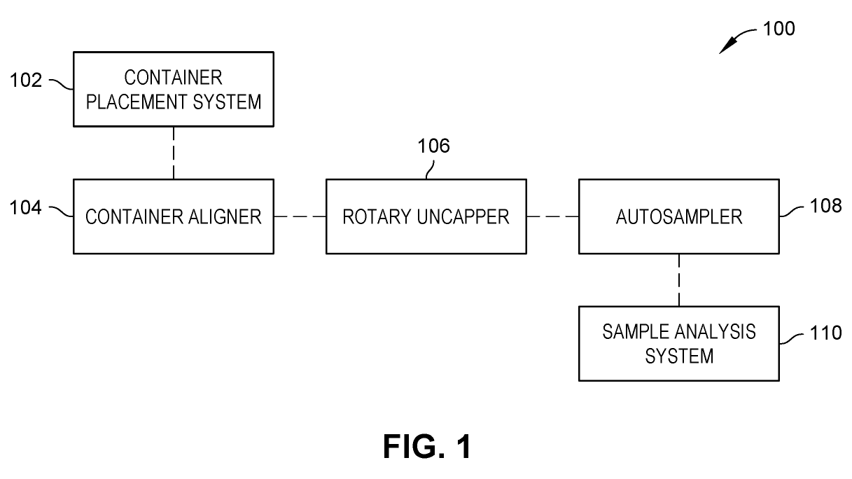

Referring to FIGS. 1 through 6, a sample container and fluid handling system (“system 100”) for automated sample container movement, alignment, and cap removal is shown in accordance with example embodiments of the present disclosure. The system 100 is shown in FIG. 1 generally including an automated container placement system 102, a container aligner 104, a rotary uncapper 106, an autosampler 108, and a sample analysis system 110. For sample containers that have generally non-cylindrical footprints (e.g., square, rectangular, oblong, irregular, etc.), the orientation of the sample container influences the ability of the system 100 to automatically remove and transfer the sample container for placement at the rotary uncapper 106, since the non-cylindrical sample containers may not have a symmetrical shape about all horizontal cross-sections through a vertical axis. The container placement system 102 transitions a sample container from a first location, such as on an initial sample deck, within a sample rack, or the like, to the container aligner 104 to rotate the sample container to provide proper orientation of the sample container for placement at the rotary uncapper 106, as described further herein. The container placement system 102 can then transfer the sample container to the rotary uncapper 106 for removal of a cap on the sample container.

Removal of the cap provides access to a fluid sample held within an interior of the sample container by a sample probe of the autosampler 108. The autosampler 108 transfers the fluid sample (e.g., with or without additional sample preparation, such as dilution, internal standard addition, reactant addition, etc.) to the sample analysis system 110 for analytic determination of one or more analytes of interest in the fluid sample. For example, the sample analysis system 110 can include, but is not limited to, an inductively-coupled plasma analysis system, such as an Inductively Coupled Plasma Mass Spectrometer (ICP/ICP-MS), an Inductively Coupled Plasma Atomic Emission Spectrometer (ICP-AES), or the like, or other sample detector or analytic instrumentation for determination of one or more analytes of interest in the sample.

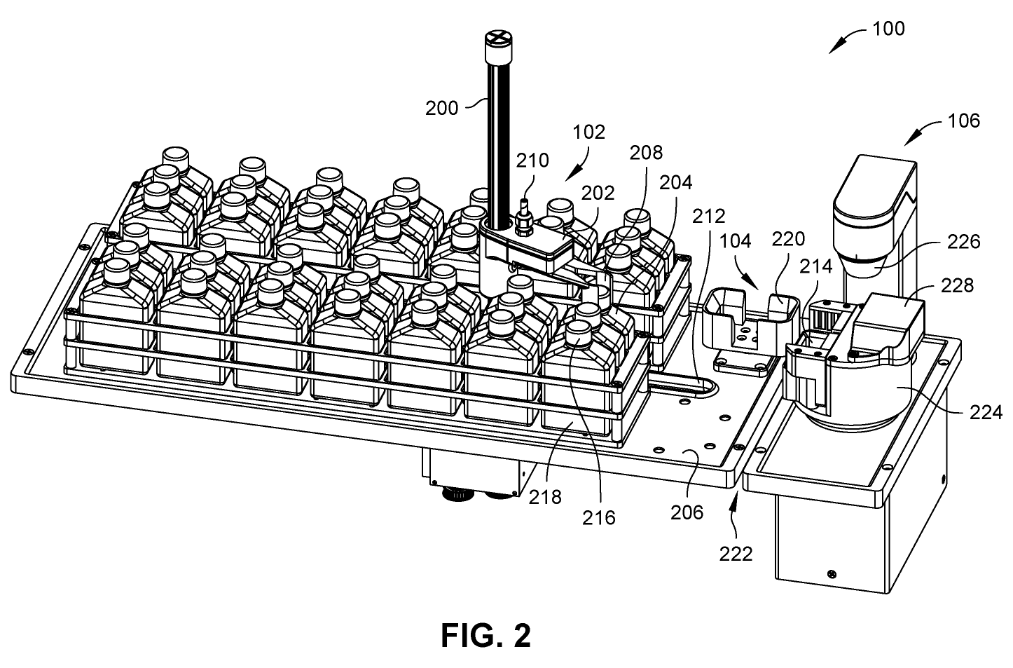

Referring to FIG. 2, example implementations of the container placement system 102, the container aligner 104, and the rotary uncapper 106 are shown. The container placement system 102 is shown including a support rod 200 supporting a gripper 202 that is configured to grab and support a sample container 204 above a sample deck 206 supporting a plurality of sample containers 204. In implementations, the gripper 202 includes pneumatically-powered tongs 208 that close and open responsive to application or removal of a pneumatic fluid (e.g., air, inert gas, etc.) introduced to an inlet port 210 of the gripper 202. The positioning of the gripper 202 is controlled through motion of the support rod 200. For example, the support rod 200 can be moved through action of a motor (not shown) to translate the support rod 200 through a slot 212 defined in the sample deck 206 and to rotate the support rod 200 about a rotational axis (e.g., a vertical rotational axis defined by the support rod 200), which in turn translates and rotates the gripper 202. The system 100 manipulates the positioning of the gripper 202 via movement of the support rod 200 to position an end of the tongs 208 about a portion of the sample container (such as a cap, lid, or other structure) to permit the gripper 202 to lift and hold the sample container 204.

The system 100 automatically moves sample containers 204 from the sample deck 206 to a container receptacle 214 at the rotary uncapper 206, where the rotary uncapper 206 can remove a cap 216 on a container base 218 of the sample container 204, such as to provide access to a fluid sample held within an interior of the sample container 204 by a sample probe of the autosampler 108. The relative orientation between a given sample container 204 on the sample deck 206 and the container receptacle 214 dictates whether the sample container 204 will be introduced to the container aligner 104 as an intermediate location during transit from the initial position of the sample container 204 on the sample deck 206 to the container receptacle 214 at the rotary uncapper 206. For instance, the sample containers 204 shown in FIG. 2 are non-cylindrically-shaped sample containers (e.g., having a footprint of an elongated rectangle with rounded corners), such that rotational motion of the support rod 200 causes the orientation of the footprint of the sample container to change. If the orientation of the sample container 204 would not match the orientation of the container receptacle 214 at the rotary uncapper 206 after the container placement system 102 would move the grippers 202 above the container receptacle 214, then the container placement system 102 introduces the sample container 204 to the container aligner 104 as an intermediate location for reorientation of the sample container 204. In general, the length of the tongs 208 of the gripper 202 is fixed to reduce the amount of moving parts above the samples containers 204 to reduce the likelihood of micro-fragments of wear and tear from landing on or in the sample containers 204 on the deck 206. As such, the system 100 manipulates the positioning of the end of the tongs 208 through movement of the support rod 200 through the slot 212 and rotation of the tongs 208 about the support rod 200. For instance, the offset of the sample containers 204 on the sample deck 206 relative to the slot 212 influences the amount of rotation and translation utilized by the support rod 200 to bring the grippers 202 in position above a respective sample container 204.

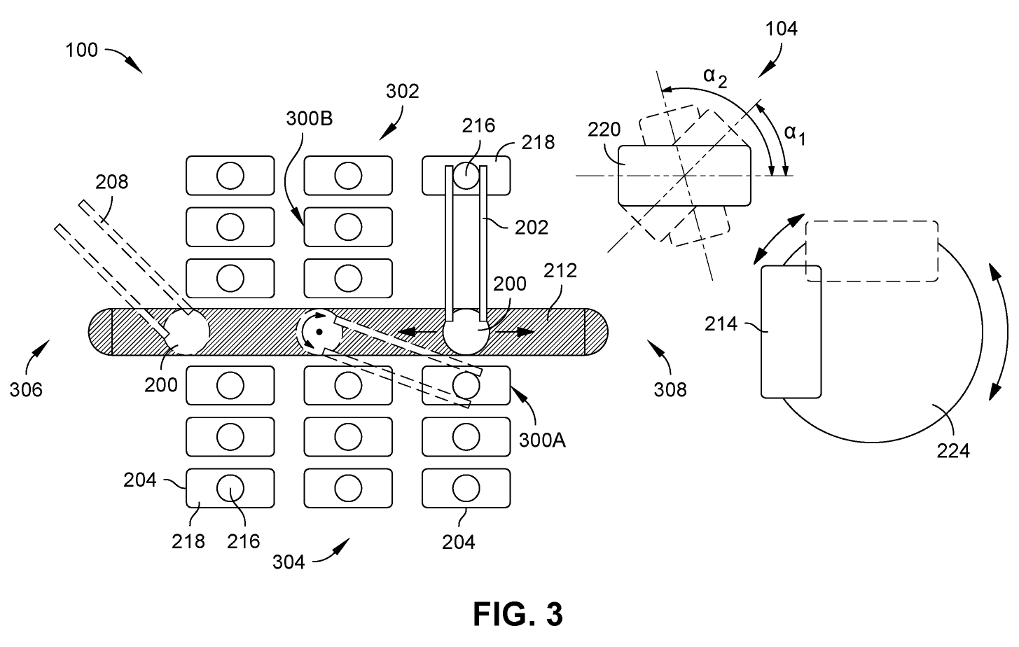

In implementations, the system 100 assigns for each position of a sample container 204 on the sample deck 206 each of an initial rotational orientation of a container receptacle 220 of the container aligner 104 and an amount of rotation of the container receptacle 220 to transition the sample container 204 from the initial rotational orientation to a rotational orientation that would match the orientation of the container receptacle 214 at the rotary uncapper 206 following rotation of the support rod 200 to move the sample container from the container aligner 104 to the container receptacle 214 at the rotary uncapper 206. For instance, referring to FIG. 3, for a first sample container 204 positioned at a first position 300A, the system 100 can assign an initial rotational orientation of the container receptacle 220 (e.g., shown as a rotational angle α₁ from horizontal) and an amount of rotation to transition the container receptacle 220 from the initial rotational angle to a second rotational angle (e.g., shown as a rotational angle α₂ from horizontal) that would match the orientation of the container receptacle 214 at the rotary uncapper 206 following rotation of the support rod 200 to move the sample container from the container aligner 104 to the container receptacle 214 at the rotary uncapper 206. In general, the initial rotational angle can be dependent upon the initial position of the sample container 204 and the amount of rotation utilized by the support rod 200 during translation along the slot 212 to reach the position of the container aligner 104.

The initial rotational angle and/or the amount of rotation for the container receptacle 220 to accommodate a second sample container 204 positioned at a different second position 300B can be different than the initial rotational angle and/or the amount of rotation for the container receptacle 220 to accommodate the first sample container 204. For instance, differences between the initial rotational orientations can be due to different amounts of rotation of the support rod 200 utilized to move the grippers 202 from the initial positions of the respective sample containers 204 (i.e., 300A, 300B) to the position of the container receptacle 220 of the container aligner 104. For example, the rotation of the support rod 200 can be due to the relative offset of the location of the given sample container 204 from the slot 212, the length of the grippers 202, the orientation of the sample container 204 with respect to the deck 206 (e.g., from an overhead perspective, in a region 302 above the slot 212, in a region 304 below the slot 212, in a region 306 to the left of the slot, in a region 308 to the right of the slot, or the like), the orientation of the sample containers 204 with respect to the container aligner 104, or the like, or combinations thereof.

In implementations, the system 100 can operate the container aligner 104 to provide an initial rotational orientation that is independent of the origin source of the sample container 204. For instance, the grippers 202 can retrieve the sample container 204 from any location on the sample deck 206 and move to position the sample container 204 above the container receptacle 220 of the container aligner 104, where the system 100 can control the positioning and rotation of the support rod 200 based on the origin location of the sample container 204 on the sample deck 206. The container receptacle 220 can be oriented in any initial rotational orientation and can then be rotated to match an orientation of the sample container 204 as held by the grippers 202 in order to place the sample container 204 into the container receptacle 220. For example, the grippers 202 can lower the sample container 204 with the container receptacle 220 positioned at an initial rotational orientation (e.g., an arbitrary rotational orientation) and the system 100 can determine whether the sample container 204 is received into the container receptacle 220, is misaligned with the container receptacle 220, or the like. For instance, the system 100 can include an imaging system to detect the relative alignment of the sample container 204 and the container receptacle 220, where feedback from the imaging system can cause the system 100 to rotate the container receptacle 220 from the initial rotational orientation until the sample container 204 and the container receptacle 220 are aligned. As another example, the container receptacle 220 can include one or more sensors to detect the presence or absence of the sample container 204 within the container receptacle 220, where if the sample container 204 is not detected, the system 100 can cause the container receptacle to rotate until the sample container 204 is detected. Once the sample container 204 is received into the container receptacle 220, the container aligner 104 can then rotate the container receptacle 220 to match the orientation of the container receptacle 214 at the rotary uncapper 206 following rotation of the support rod 200 to move the sample container from the container aligner 104 to the container receptacle 214 at the rotary uncapper 206, where such amount can depend the particular orientation of the container receptacle 220 when the container receptacle 220 received the sample container 204.

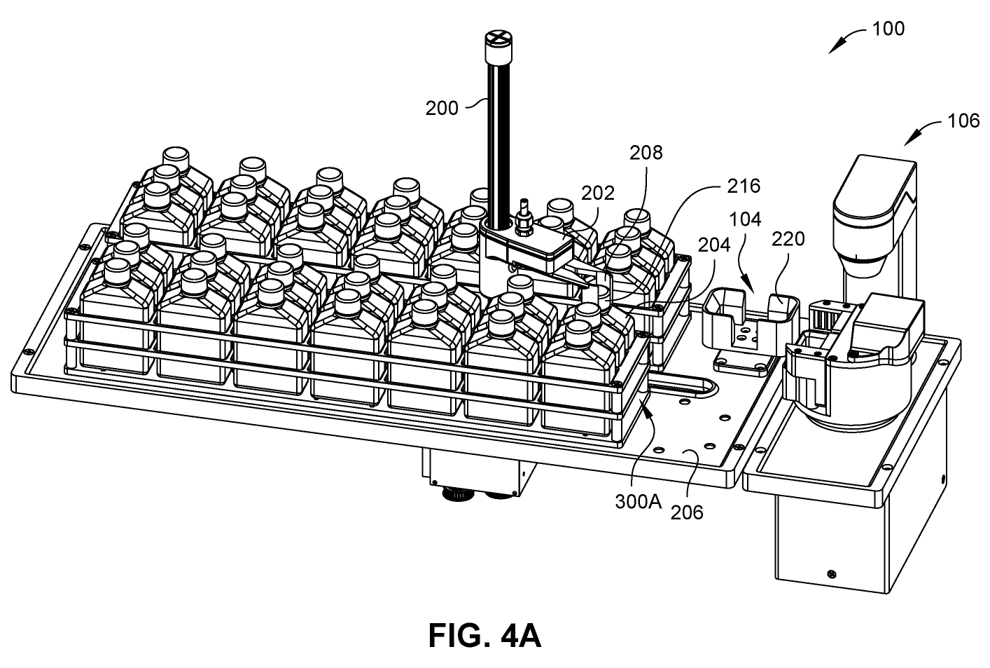

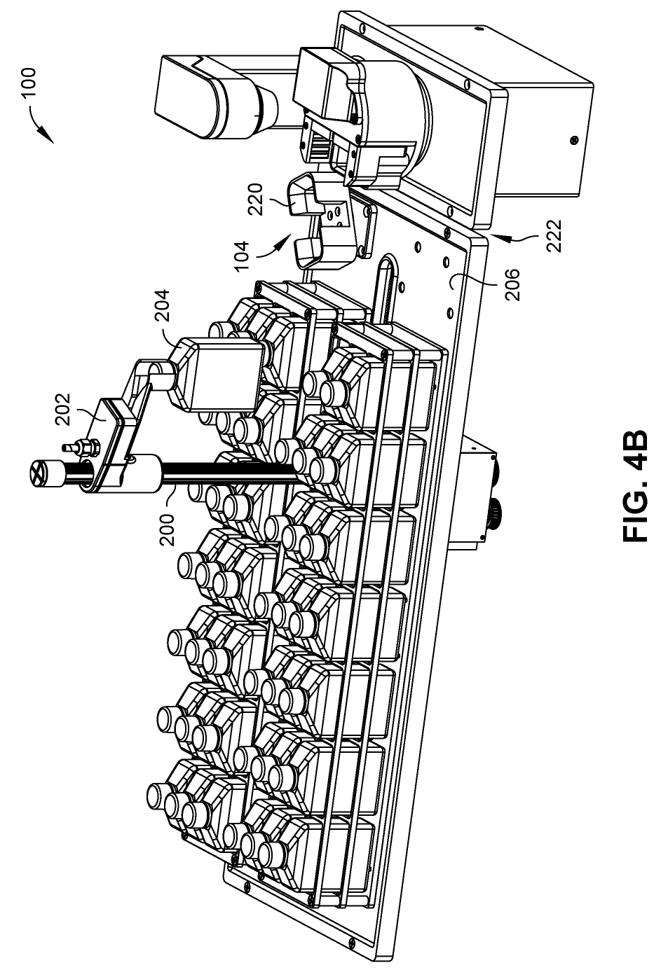

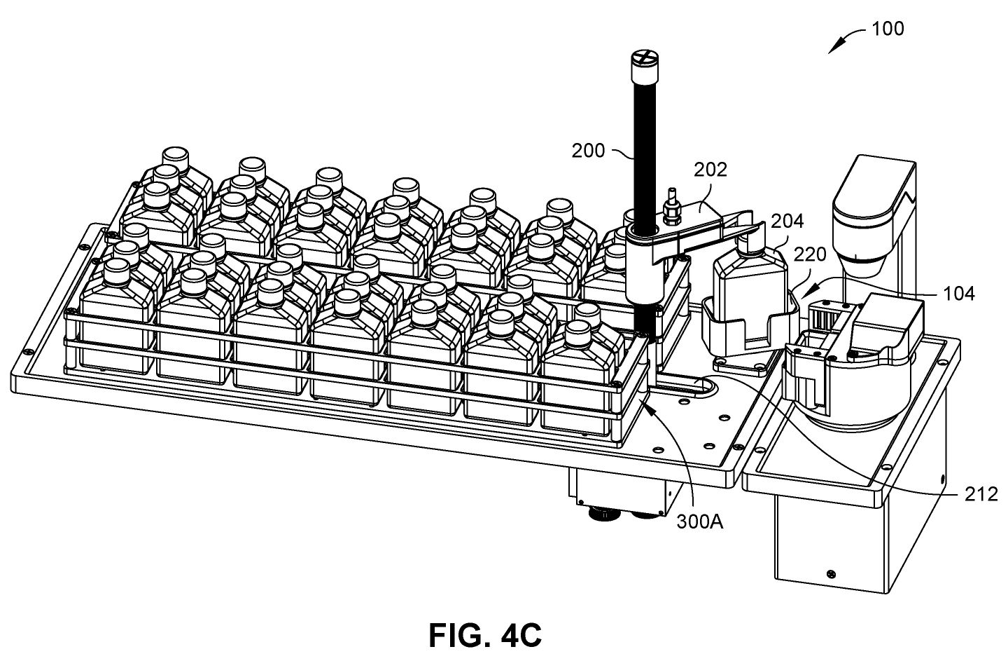

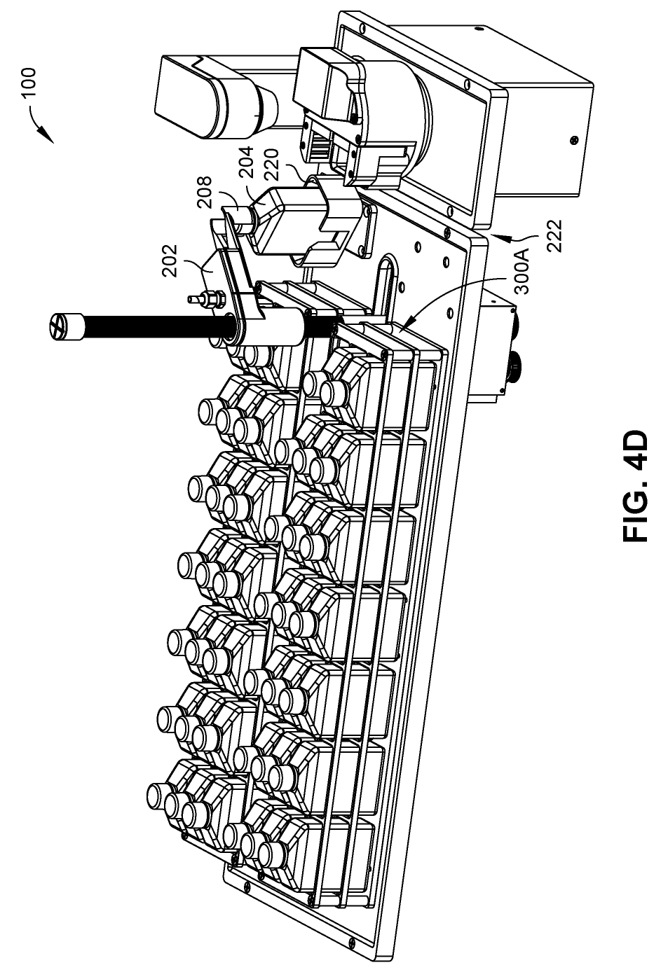

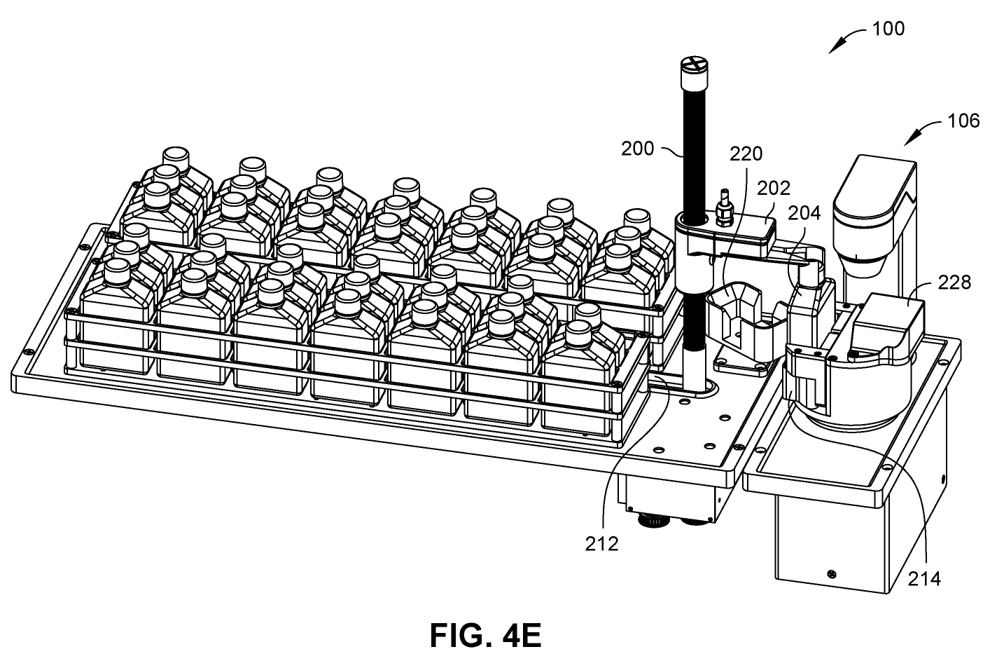

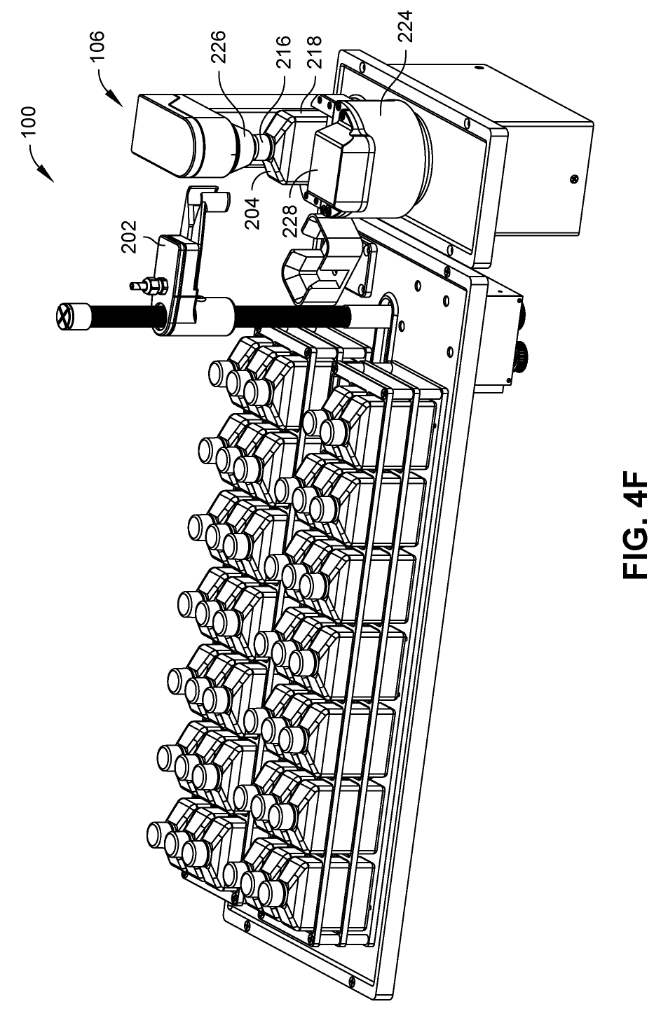

Referring to FIGS. 4A through 4F, an example operation of the system 100 is shown to transition the sample container 204 from the first position 300A to the rotary uncapper 106 to remove the cap 216 from the sample container 204. For instance, the system 100 can instruct a motor system manipulating the support rod 200 to move the support rod 200 such that the grippers 202 are positioned above the sample container 204 on the sample deck 206 at the first position 300A and lower the grippers 202 to position the tongs 208 around the cap 216 of the sample container 204, as shown in FIG. 4A. The system 100 is shown in FIG. 4B having transitioned the container receptacle 220 of the container aligner 104 from a horizontal orientation (e.g., shown in FIG. 4A) to the initial rotational orientation set by the system 100 for a sample container 204 retrieved from the first position 300A (e.g., rotational angle α₁ shown in FIG. 3), such as through operation of an alignment motor 222. Alternatively or additionally, the initial rotation orientation can be independent of the origin source of the sample container 204 with subsequent alignment of the container receptacle 220 and the sample container 204, as described herein. The system 100 is also shown in FIG. 4B having transitioned the grippers 202 from a lowered position relative to the sample deck 206 (e.g., shown in FIG. 4A) to a raised position relative to the sample deck 206 while gripping and raising the sample container 204 above the sample deck 206. For instance, a motor used to translate and rotate the support rod 200 can be used to raise and lower the grippers along the support rod 200.

Referring to FIG. 4C, the system 100 is shown having rotated the support rod 200 to rotate the grippers 202 to cause the gripped sample container 204 to match the initial rotational orientation of the container receptacle 220 and having translated the support rod 200 along the slot 212 to reposition the grippers 202 from the first position 300A to an intermediate position above the container aligner 104 to place the sample container 204 within the container receptacle 220. Referring to FIG. 4D, the system 100 is shown having rotated the container receptacle 220 of the container aligner 104 through action of the motor 222 from the initial rotational orientation to the second rotational angle (e.g., by rotating according to the preset amount of rotation for the initial position 300A, by noting the rotational orientation of the container receptacle 220 when it received the sample container 204, or the like). For instance, the tongs 208 of the grippers 202 can release or otherwise loosen grip on the cap 216 to permit the container receptacle 220 to rotate the sample container 204 without interference from the grippers 202.

Referring to FIG. 4E, the system 100 is shown having removed the sample container 204 from the container receptacle 220, rotated the support rod 200 to transition the sample container 204 from the second rotational angle (e.g., shown in FIGS. 4D and 4E) to the orientation of the container receptacle 214 of the rotary uncapper 106, translated the support rod 200 along the slot 212 to position the grippers 202 above the container receptacle 214, and lowered the grippers 202 along the support rod 200 to place the sample container 204 into the container receptacle 214. Referring to FIG. 4F, the system 100 is shown having the gripper 202 release the cap 216 and a rotary stage 224 of the rotary uncapper 106 rotate the container receptacle 214 (e.g., via operation of a motor of the rotary uncapper 106, not shown) to position the sample container 204 beneath an uncapper head 226 configured to remove (e.g., unscrew) the cap 216 from the container base 218, where the rotary stage 224 can be subsequently rotated to move the container base 218 into position to provide access to a fluid sample held within an interior of the container base 218 by a sample probe of the autosampler 108.

The system 100 can reverse the steps described above to replace the sample container 204 back to its original position on the sample deck 206. For instance, the rotary stage 224 can move the sample container 204 back to a position underneath the grippers 202, where the grippers 202 can move the sample container 204 to the container receptacle 220 of the container aligner 104, which in turn can rotate the sample container 204 into position to be transferred back the initial position 300A. Alternatively or additionally, the system 100 can place the sample container 204 to a different location on the sample deck 206. The system 100 can then proceed to processing a different sample container 204 from another location on the sample deck 206.

In implementations, the rotary uncapper 106 includes a container scanner 228 configured to scan, image, or otherwise recognize a label on the sample container 204 to provide the system 100 with information about the sample container 204, the sample held therein, analyses to be performed on the sample, and the like, and combinations thereof. The label can include, but is not limited to, an image, a barcode (e.g., 2D barcode, matrix barcode, etc.), characters for character recognition, or the like, or combinations thereof. For instance, bringing the label on the sample container 204 into a scanning area of the container scanner 228 can cause the system 100 to access identifying information associated with the label, such as by accessing a data table associated with identifying information on the label. For example, the system 100 can automatically execute a sample preparation procedure on fluid sample held within the sample container 204 following uncapping by the rotary uncapper 106 based on the analysis type data stored with respect to the identifying information on that specific label.

In implementations, if the orientation of the label on the sample container 204 is such that the label is not within the scanning area of the container scanner 228 when the sample container 204 is received in the container receptacle 214 at the rotary uncapper 206 (such as if the label is affixed to a single side of the sample container 204 facing away from the container scanner 228), then the system 100 can direct the grippers 202 to reintroduce the sample container 204 to the container aligner 104. The container aligner 104 can then rotate the sample container 204 180-degrees such that the grippers 202 can reintroduce the sample container 204 to the container receptacle 214 at the rotary uncapper 206 with the sample container 204 in the reverse orientation to bring the label on the sample container 204 within the scanning area of the container scanner 228. Alternatively or additionally, the container aligner 104 can include a container scanner 228 or other identifier to identify the label prior to introduction to the rotary uncapper 206 or to ensure that the sampler container 204 is properly oriented such that the sample container 204 can be introduced to the container receptacle 214 at the rotary uncapper 206 with the label in the scanning area of the container scanner 204 on the first introduction by the container placement system 102.

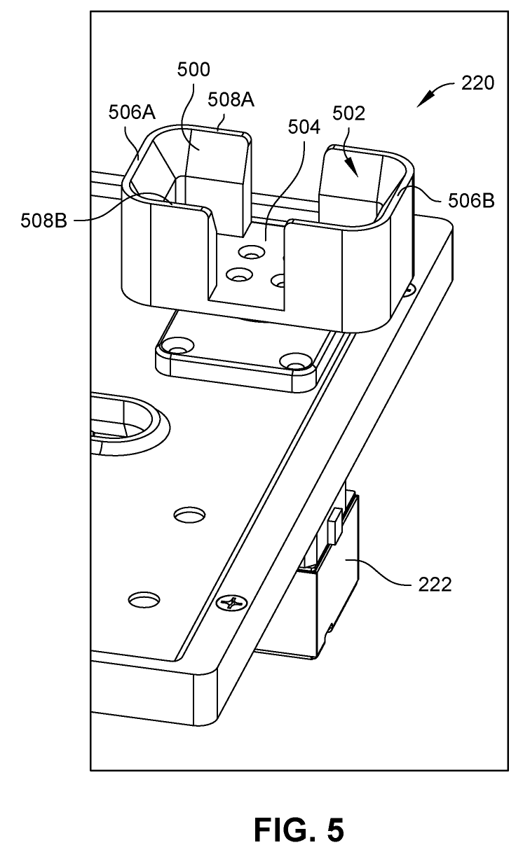

Referring to FIG. 5, an example implementation of the container receptacle 220 of the container aligner 214 is shown. The container receptacle 220 is shown including a tapered surface 500 at an entry side 502 of the container receptacle 220 to provide a margin of error for alignment of the container placement system 102 during placement by the container placement system 102, where the tapered surface 500 can direct the sample container 104 smoothly into contact with a base 504 of the container receptacle 220. In implementations, the container receptacle 220 can include opposing sidewalls (e.g., opposing sidewalls 506A, 506B and 508A, 508B are shown) that are expandable or retractable to provide flexibility in the size/shape of sample containers 204 that can be received by the container aligner 104 with a single container receptacle 220. For example, the positioning of the opposing sidewalls can be controlled through motor action to drive the sidewalls closer or further relative to each other, can be biased with a spring or other tensioner, or the like, or combinations thereof. In implementations, the container receptacle 220 can be spun by the motor 222 of the container aligner 104 at rotational speeds suitable to induce mixing of the sample held within the sample container 204, such as to induce vortex mixing within the sample container 204. Alternatively or additionally, the container receptacle 214 of the rotary uncapper 106 can include the above-described features of the container receptacle 220.

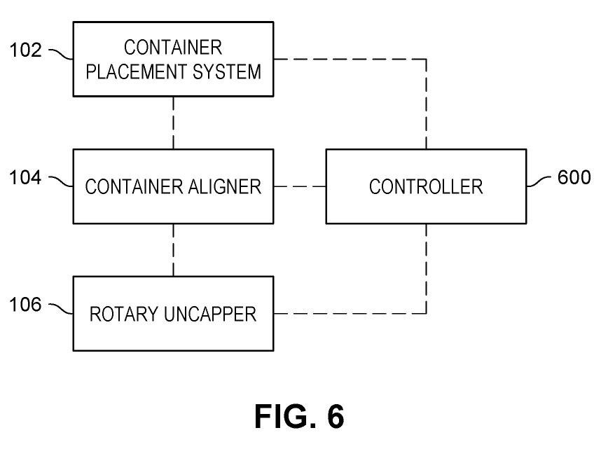

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller (e.g., controller 600 in FIG. 6) configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the container placement system 102, the container aligner 104, the rotary uncapper 106, the autosampler 108, the sample analysis system 110, alternative or additional fluid handling systems (e.g., valves, pumps, etc.), other components described herein, components directing control thereof, or combinations thereof. The program instructions, when executed by the processor or other controller, can cause the computing system to control the system 100 (e.g., control operation of the grippers 202, control positioning of the container aligner 104, control positioning of the uncapper head 226, the rotary stage 224, or the sample probe of the autosampler 108, control movement of fluids via the sample probe, etc.), control operation of the container scanner 228, or the like, according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An automated container alignment system for fluidic sample analysis, comprising:
a container aligner including a rotatable first container receptacle configured to receive a sample container containing a fluid sample for analysis;
a container placement system configured to retrieve a sample container having a cap positioned on a container base, the sample container having an initial position on a sample deck, the container placement system configured to transfer the sample container from the initial position to the first container receptacle;
an uncapper system configured to remove the cap from the container base, the uncapper system including a second container receptacle; and
a computer controller communicatively coupled with the container aligner and the container placement system, the computer controller configured to
instruct the container aligner to rotate the first container receptacle to receive the sample container in an initial rotational orientation, and
instruct the container aligner to further rotate the container receptacle from the initial rotational orientation to a second rotational orientation to align the sample container with the second container receptacle following transition of the sample container to the second container receptacle by the container placement system.

2. The automated container alignment system of claim 1, wherein the sample container is a non-cylindrically-shaped container.

3. The automated container alignment system of claim 1, wherein the container receptacle includes tapered sidewalls at a top portion to receive the sample container.

4. The automated container alignment system of claim 1, wherein the computer controller is configured to instruct the container aligner to orient the container receptacle according to the initial rotational orientation dependent upon the initial position on the sample deck to receive the sample container and to subsequently rotate the first container receptacle by an amount that is also dependent upon the initial position on the sample deck.

5. The automated container alignment system of claim 1, wherein the container placement system includes a support rod supporting mechanical grippers configured to grasp and move the sample container.

6. The automated container alignment system of claim 5, wherein the computer controller is configured to instruct the container placement system to translate the support rod through a slot in the sample deck and to rotate about a rotational axis defined by the support rod to provide translational and rotational movement of the mechanical grippers.

7. The automated container alignment system of claim 6, wherein the initial rotational orientation is dependent upon rotation and translation of the support rod to move the sample container from the initial position on the sample deck to the first container receptacle.

8. The automated container alignment system of claim 6, wherein the amount of subsequent rotation is dependent upon rotation and translation of the support rod to move the sample container from the container aligner to the second container receptacle.

9. The automated container alignment system of claim 1, wherein the uncapper system includes a rotary stage configured to rotate about a vertical axis, and wherein the second container receptacle is positioned on the rotary stage.

10. The automated container alignment system of claim 1, wherein at least one of the first container receptacle and the second container receptacle is a non-cylindrically-shaped receptacle.

11. An automated container alignment system for fluidic sample analysis, comprising:
a container aligner including a rotatable container receptacle configured to receive a sample container containing a fluid sample for analysis; and
a container placement system configured to retrieve a sample container from an initial position on a sample deck and place the sample container into the container receptacle,
wherein the container aligner is configured to rotate the container receptacle to receive the sample container in an initial rotational orientation and to further rotate the container receptacle from the initial rotational orientation to align the sample container with a second container receptacle following transition of the sample container to the second container receptacle by the container placement system.

12. The automated container alignment system of claim 11, wherein the sample container is a non-cylindrically-shaped container.

13. The automated container alignment system of claim 11, wherein the container receptacle includes tapered sidewalls at a top portion to receive the sample container.

14. The automated container alignment system of claim 11, wherein the container aligner is configured to orient the container receptacle according to the initial rotational orientation dependent upon the initial position on the sample deck to receive the sample container and to subsequently rotate the container receptacle by an amount that is also dependent upon the initial position on the sample deck.

15. The automated container alignment system of claim 14, wherein the container placement system includes a support rod supporting mechanical grippers configured to grasp and move the sample container.

16. The automated container alignment system of claim 15, wherein the support rod is configured to translate through a slot in the sample deck and to rotate about a rotational axis defined by the support rod to provide translational and rotational movement of the mechanical grippers.

17. The automated container alignment system of claim 16, wherein the initial rotational orientation is selected based upon rotation and translation of the support rod to move the sample container from the initial position on the sample deck to the container receptacle.

18. The automated container alignment system of claim 16, wherein the amount of subsequent rotation is selected based upon rotation and translation of the support rod to move the sample container from the container aligner to the second container receptacle.

19. The automated container alignment system of claim 18, wherein the second container receptacle is positioned at a rotary uncapper configured to remove a cap from the sample container.

20. The automated container alignment system of claim 19, wherein the second container receptacle is positioned on a rotary stage configured to rotate about a vertical axis at the rotary uncapper.
